(19) United States
(12) Patent Application Publication
(10) Pub. No.: US 2022/0025102 A1
(43) Pub. Date: Jan. 27, 2022

(54) POLYURETHANE MICROCELLULAR ELASTOMER, NON-PNEUMATIC TIRE AND PREPARATION PROCESS THEREOF

(71) Applicant: Covestro Intellectual Property GmbH & Co. KG, Leverkusen (DE)

(72) Inventors: Zhong Cao, Shanghai (CN); Hui Yu, Shanghai (CN); Qingyun Wang, Shanghai (CN); Hiroshi Ikuta, Hyogo (JP); Masaru Suzuki, Hyogo (JP)

(21) Appl. No.: 17/296,860

(22) PCT Filed: Nov. 21, 2019
(86) PCT No.: PCT/EP2019/082011

§ 371 Date: May 25, 2021

(30) Foreign Application Priority Data
Dec. 7, 2018 (CN) 201811500506.3
Jan. 15, 2019 (EP) 19151988.3

(51) Int. Cl. C08G 18/38; C08G 18/48; B29D 30/02; C08G 18/10

(52) U.S. Cl. CPC C08G 18/3814; C08G 18/48; C08G 2101/00; C08G 18/10; C08G 2110/0083; B29D 30/02

(57) ABSTRACT

The present invention relates to a polyurethane microcellular elastomer, a non-pneumatic tire and a preparation process and use thereof. The polyurethane microcellular elastomer of the present invention is obtained by reaction of a reaction system comprising components such as isocyanate, ethylene diamine-started polyoxypropylene ether tetraol, a catalyst and a foaming agent. The non-pneumatic tire of the present invention has very strong fatigue resistance and can be used for non-motor vehicles running at high speed.

### CROSS REFERENCE TO RELATED APPLICATIONS

This application is a U.S. national stage application, filed under 35 U.S.C. § 371, of

International Application No. PCT/EP2019/082011, which was filed on Nov. 21, 2019, and which claims priority to European Patent Application No. 19151988.3, which was filed on Jan. 15, 2019 and Chinese Patent Application No. 201811500506.3, which was filed on Dec. 7, 2018. The contents of each are hereby incorporated by reference into this specification.

### TECHNICAL FIELD

The present invention relates to a polyurethane microcellular elastomer, a non-pneumatic tire and a preparation process and use thereof. The non-pneumatic tire is mainly applied to non-motor vehicles.

### BACKGROUND

At present, two types of tires, i.e. pneumatic tires and non-pneumatic tires are usually used as tires in low-speed vehicles such as bicycles. Non-pneumatic tires are also known as filled tires or solid tires. Because the filled solid or semi-solid material is not compressed air, there is no problem of air inflation or leakage. The non-pneumatic tires can thus be substantially maintenance-free during their service life.

It has been tried in the industry to use polyurethane elastomers for preparing non-pneumatic tires. However, the problem of short service life due to insufficient fatigue resistance of polyurethane elastomers remains to be solved.

CN107532037A discloses a system for forming an elastomeric composition for application to a substrate, the system comprising an isocyanate component and an isocyanate-reactive component. The isocyanate component comprises a polymeric polyisocyanate and optionally an isocyanate-terminated prepolymer. The isocyanate-reactive component can react with the isocyanate component and comprises a polyol component and a polyetheramine. The polyol component is a mixture of (a) a hydrophobic polyol; (b) a polyether polyol different from the hydrophobic polyol and having a weight average molecular weight greater than 500 g/mol; and (c) a polyaminopolyol. The elastomeric composition is formed as a reaction product of the isocyanate component and the isocyanate-reactive component and can be applied as an elastomeric coating to a substrate such as a steel tube. The steel tube with an applied elastomeric coating meets the criteria for the water supply industry as set forth in AWWAC222.

CN1079803C discloses a process for improving green strength and demold time of polyurethane elastomers prepared by the reaction of an isocyanate component with a polyoxyalkylene diol and one or more chain extenders. The process includes selecting a polyoxyalkylene polyol component having an unsaturation of less than 0.010 meq/g, a polydispersity of 1.4 or greater as said polyoxyalkylene polyol, and comprising a polyoxypropylene polyol component having an unsaturation of less than 0.010 meq/g, said polyoxyalkylene polyol component having an average equivalent weight of from 1000 Da to 8000 Da; wherein when said polyoxypropylene polyol component comprises a blend of individual polyoxypropylene polyols, each of said individual polyoxypropylene polyols is an essentially monodisperse polyoxypropylene polyol with an unsaturation of less than 0.015 meq/g. A polyurethane elastomer composition for producing a tire, a process for producing the tire, and a tire made of the polyurethane elastomer. Said tire is particularly suitable for use as a tire for a low speed vehicle, such as a bicycle tire.

CN105939870A discloses a polyurethane filled tire. The tire provided by the invention is produced from a cellular polyurethane elastic material having a molded density of 400 to 700 kg/m³, preferably 500 to 600 kg/m³ and a free rise density of 250 to 350 kg/m³, preferably 300 to 320 kg/m³ (according to ISO 845). The filler material used is an improved cellular polyurethane or polyurethane-urea elastic material.

In the prior art, the fatigue resistance and service life of tires are often seriously affected by the generated heat when a non-pneumatic tire is operated at a higher speed (for example 15 km/h). Therefore, a non-pneumatic tire with good fatigue resistance and long service life, while maintaining the advantages of pneumatic tires, is still urgently needed in the industry.

### SUMMARY OF THE INVENTION

In one aspect of the present invention, a polyurethane microcellular elastomer is provided which is obtained from a reaction system comprising the following components:

a component A, one or more polyisocyanates;

a component B, including:
B1) at least one ethylene diamine-started polyoxypropylene ether tetraol having a weight average molecular weight of 280 to 560 g/mol, preferably 320 to 450 g/mol (as determined according to GB/T 7383-2007) in a content of 0.5 to 3 wt %, preferably 0.5 to 2 wt %, more preferably 0.5 to 1.5 wt %, based on the total weight of the component B;
B2) at least one polytetramethylene ether glycol having a weight average molecular weight of 650 to 2000 g/mol, preferably 1000 to 2000 g/mol (as determined according to GB/T 7383-2007) in a content of 80 to 90 wt %, preferably 82 to 88 wt %, based on the total weight of the component B;
B3) one or more catalysts; and
B4) one or more foaming agents.

Preferably, the polyisocymate is a NCO-terminated isocyanate prepolymer having a NCO content of 15 to 25 wt % (as determined according to GBT 18446-2009), based on the total weight of the isocyanate prepolymer. Preferably, the isocyanate prepolymer is prepared by reaction of 30 to 45 wt % of polytetramethylene ether glycol with 55 to 70 wt % of diphenylmethane diisocyanate (MDI), based on the total weight of the isocyanate prepolymer.

Preferably, the foaming agent is water, which is present in a content of 0.2 to 1 wt %, preferably 0.3 to 0.7 wt %, based on the total weight of the component B.

Preferably, the component B further comprises B5) at least one alcohol, alcohol amine or diamine-based chain extender having a low molecular weight, which is present in a content of 7 to 15 wt %, preferably 9 to 13 wt %, based on the total weight of the component B.

Preferably, the component B further comprises B6) at least one surfactant, which is present in a content of 0.1 to 1.0 wt %, preferably 0.2 to 0.6 wt %, based on the total weight of the component B.

Optionally, the component B further comprises one or more antioxidants, which is/are present in a content of 0 to 2 wt %, based on the total weight of the component B.

Optionally, the component B further comprises one or more colorants/color pastes, which is/are present in a content of 0 to 2 wt %, based on the total weight of the component B.

Preferably, the polyurethane microcellular elastomer has a resilience of >50%, preferably >51%, more preferably >52%.

The polyurethane microcellular elastomer of the present invention has other satisfactory physical properties such as excellent resilience performance while having excellent fatigue resistance. The polyurethane microcellular elastomer of the present invention can be used not only for a non-pneumatic tire but also for preparing a shoe sole or a shockproof/shock-absorbing device.

Another aspect of the present invention is to provide a non-pneumatic tire. The non-pneumatic tire comprises the polyurethane microcellular elastomer of the present invention, which is obtained from a reaction system comprising the following components:
a component A, one or more polyisocyanates;
a component B, including:
   B1) at least one ethylene diamine-started polyoxypropylene ether tetraol having a weight average molecular weight of 280 to 560 g/mol, preferably 320 to 450 g/mol (as determined according to GB/T 7383-2007) in a content of 0.5 to 3 wt %, preferably 0.5 to 2 wt %, more preferably 0.5 to 1.5 wt %, based on the total weight of the component B;
   B2) at least one polytetramethylene ether glycol having a weight average molecular weight of 650 to 2000 g/mol, preferably 1000 to 2000 g/mol (as determined according to GB/T 7383-2007) in a content of 80 to 90 wt %, preferably 82 to 88 wt %, based on the total weight of the component B;
   B3) one or more catalysts; and
   B4) one or more foaming agents.

Preferably, the polyisocyanate is a NCO-terminated isocyanate prepolymer having a NCO content of 15 to 25 wt % (as determined according to GBT 18446-2009), based on the total weight of the isocyanate prepolymer. More preferably, the isocyanate prepolymer is prepared by reaction of 30 to 45 wt % of polytetramethylene ether glycol with 55 to 70 wt % of diphenylmethane diisocyanate (MDI), based on the total weight of the isocyanate prepolymer.

Preferably, the foaming agent is water, which is present in a content of 0.2 to 1 wt %, preferably 0.3 to 0.7 wt %, based on the total weight of the component B.

Preferably, the component B further comprises B5) at least one alcohol, alcohol amine or diamine -based chain extender having a low molecular weight, the chain extender having a low molecular weight having a content of 7 to 15 wt %, preferably 9 to 13 wt %, based on the total weight of the component B.

Preferably, the component B further comprises B6) at least one surfactant, which is present in a content of 0.1 to 1.0 wt %, preferably 0.2 to 0.6 wt %, based on the total weight of the component B.

Optionally, the component B further comprises one or more antioxidants, which is/are present in a content of 0 to 2 wt %, based on the total weight of the component B.

Optionally, the component B further comprises one or more colorants/color pastes, which is/are present in a content of 0 to 2 wt %, based on the total weight of the component B.

Preferably, the polyurethane microcellular elastomer has a resilience of >50%, preferably >51%, more preferably >52%.

Preferably, the non-pneumatic tire further comprises at least a rubber layer disposed on the outer side of the polyurethane microcellular elastomer.

In still another aspect of the present invention, a process for producing a non-pneumatic tire of the present invention is provided. The process comprises injecting a polyurethane reaction system into a mold, reacting, and then releasing the resultant from the mold after the completion of the reaction to obtain the non-pneumatic tire, wherein the polyurethane reaction system comprises the following components:
a component A, one or more polyisocyanates;
a component B, including:
   B1) at least one ethylene diamine-started polyoxypropylene ether tetraol having a weight average molecular weight of 280 to 560 g/mol, preferably 320 to 450 g/mol (as determined according to GB/T 7383-2007) in a content of 0.5 to 3 wt %, preferably 0.5 to 2 wt %, more preferably 0.5 to 1.5 wt %, based on the total weight of the component B;
   B2) at least one polytetramethylene ether glycol having a weight average molecular weight of 650 to 2000 g/mol, preferably 1000 to 2000 g/mol (as determined according to GB/T 7383-2007) in a content of 80 to 90 wt %, preferably 82 to 88 wt %, based on the total weight of the component B;
   B3) one or more catalysts; and
   B4) one or more foaming agents.

Preferably, the polyisocyanate is a NCO-terminated isocyanate prepolymer having a NCO content of 15 to 25 wt % (as determined according to GBT 18446-2009), based on the total weight of the isocyanate prepolymer. More preferably, the isocyanate prepolymer is prepared by reaction of 30 to 45 wt % of polytetramethylene ether glycol with 55 to 70 wt % of diphenylmethane diisocyanate (MDI), based on the total weight of the isocyanate prepolymer.

Preferably, the mold comprises space for forming the non-pneumatic tire. More preferably, the mold is a mold comprising space for forming a bicycle tire.

Preferably, the polyurethane reaction system is injected by centrifugal casting.

Preferably, the reaction system further comprises B5) at least one alcohol, alcohol amine or diamine-based chain extender having a low molecular weight, which is present in a content of 7 to 15 wt %, preferably 9 to 13 wt %, based on the total weight of the component B.

Preferably, the polyurethane microcellular elastomer has a resilience of >50%, preferably >51%, more preferably >52%.

Preferably, the process further comprises disposing at least a rubber layer on the outer side of the non-pneumatic tire.

In still another aspect of the present invention, use of the non-pneumatic tire of the present invention in non-motor vehicles having at least two wheels, which may reach a speed of <50 km/h, preferably 20 km/h to 50 km/h, more preferably 30 km/h to 50 km/h, is provided.

In a further aspect of the present invention, a non-motor vehicle comprising at least one non-pneumatic tire of the present invention is provided.

Preferably, the non-motor vehicle is a bicycle, more preferably an electric bicycle.

Preferably, said at least one non-pneumatic tire refers to two non-pneumatic tires.

Through repeated experiments, we have unexpectedly found that the polyurethane microcellular elastomer of the present invention using the ethylene diamine-started polyoxypropylene ether tetraol and corresponding components of the polyurethane reaction system has other satisfactory physical properties such as an excellent resilience effect while having excellent fatigue resistance, and is well shock-absorbing. The non-pneumatic tire prepared from the polyurethane microcellular elastomer of the present invention can pass a rigorous fatigue resistance test, and has a long service life even when used for non-motor vehicles at high speed (for example 40 km/h).

### DESCRIPTION OF THE DRAWINGS

FIG. 1 shows a photograph of a tire obtained in Example 1 after the fatigue resistance test, wherein the right picture is a photograph of the inner tube after the test;

FIG. 2 shows a photograph of a tire obtained in Comparative Example 2 after the fatigue resistance test, wherein the right picture is a photograph of a part of the inner tube after the test;

FIG. 3 shows a photograph of the tire obtained in Comparative Example 3 after the fatigue resistance test, wherein the right picture is a photograph of a part of the inner tube after the test.

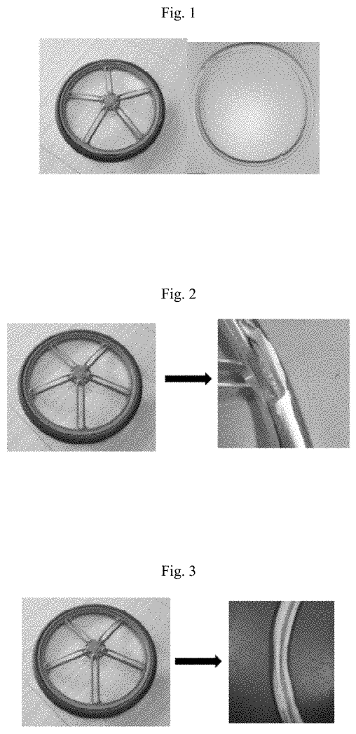

The drawings are used to further describe the specific embodiments and processes disclosed in the present invention. The drawings and description thereof are illustrative and not restrictive.

### DETAILED DESCRIPTION

The present invention is further illustrated below with reference to specific embodiments. It is to be understood that the examples are not intended to limit the scope of the present invention but illustrate it. In addition, it should be understood that various modifications and changes may be made to the present invention by those skilled in the art according to the teaching of the present invention. Such equivalents also fall within the scope defined by the claims of the present invention.

Polyurethane Microcellular Elastomer

Isocyanate

The polyisocyanates useful in the preparation of the present invention include aliphatic, cycloaliphatic and araliphatic polyisocyanates such as hexamethylene diisocyanate, isophorone diisocyanate, cyclohexane-1,4-diisocyanate, dicyclohexylmethane-4,4-diisocyanate and p-xylylene diisocyanate. Useful polyisocyanates also include isocyanate prepolymers/isocyanate-terminated prepolymers.

Preferable polyisocyanates are aromatic polyisocyanates such as phenylene diisocyanate, toluene diisocyanate, 1,5-naphthalene diisocyanate and polyisocyanates based on diphenylmethane diisocyanate (MDI), such as MDI isomers, i.e. 4,4-diphenylmethane diisocyanate, 2,4-diphenylmethane diisocyanate and mixtures thereof.

More preferably, the amount of 4,4-diphenylmethane diisocyanate used as the organic polyisocyanate is greater than 95 wt %, based on the total weight of the organic polyisocyanates. Most preferably, the amount of 4,4-diphenylmethane diisocyanate used as the organic polyisocyanate is greater than 97 wt %, based on the total weight of the organic polyisocyanates.

When the diisocyanate is the preferable polyisocyanate useful in the preparation of isocyanates, a mixture of diisocyanate and a small proportion of higher-functional polyisocyanate can be used if desired. Other MDI variants are well known in the art and include a liquid product obtained by incorporating urethane, allophanate, urea, biuret, carbodiimide, uretonimine and/or isocyanurate residues.

The isocyanate-terminated prepolymer is prepared by reaction of an excess of polyisocyanate with a polyether polyol or polyester polyol to obtain a prepolymer having a specified NCO value. All processes for preparing prepolymers known to those skilled in the art can be used to prepare the isocyanate prepolymers useful in the present invention. The relative amount of the polyisocyanate and the polyether polyol depends on their equivalents and the desired NCO value and can be readily determined by those skilled in the art. If desired, the reaction can be carried out in the presence of a catalyst which enhances the formation of a urethane group, such as a tertiary amine and a tin compound. The reaction time may be 30 minutes to 4 hours, and the reaction temperature may be 50 to 90° C.

Optionally, at least 90% of the groups obtained by the reaction of the polyisocyanate with the polyether polyol used to prepare the prepolymer are polyurethane groups. A polyisocyanate may be added to the prepolymer prepared in the above way, provided that the NCO value is kept within the specified range. The added amount is usually less than 25 wt %, based on the total weight of the isocyanates. The polyisocyanate added may be selected from the group consisting of those described as above. Aromatic polyisocyanates, especially MDI-based polyisocyanates, are preferable.

Preferably, the polyisocyanate is preferably a NCO-terminated isocyanate prepolymer having a NCO content of 15 to 25 wt % (as determined according to GBT 18446-2009), based on the total weight of the isocyanate prepolymer. In an embodiment of the present invention, the isocyanate prepolymer is obtained by reaction of 30 to 45 wt % of polytetramethylene ether glycol with 55 to 70 wt % of diphenylmethane diisocyanate (MDI) based on the total weight of the isocyanate prepolymer.

Polyol

Polyols useful in the present invention include, but are not limited to, polyether polyols, polyester polyols, and/or polycarbonate polyols, and the like.

The polyether polyol used to prepare the isocyanate-terminated prepolymer includes a product obtained by polymerization of ethylene oxide with other cyclic oxides such as propylene oxide or tetrahydrofuran in the presence of a polyfunctional initiator. A suitable initiator compound comprises a plurality of active hydrogen atoms and includes water and polyols such as ethylene glycol, propylene glycol, diethylene glycol, dipropylene glycol, cyclohexane dimethanol, resorcinol, bisphenol A, glycerol, trimethylolpropane, 1,2,6-hexanetriol or pentaerythritol. Mixtures of initiators and/or cyclic oxides can also be used.

Useful polyether polyols also include poly(oxyethylene-oxypropylene) diols and triols obtained by sequential addition of propylene oxide and ethylene oxide to a di- or trifunctional initiator, as fully described in the prior art. Mixtures of the diol and triol can also be used.

In particular, the reaction system of the polyurethane microcellular elastomer of the present invention comprises the following components:

B1) at least one ethylene diamine-started polyoxypropylene ether tetraol having a weight average molecular weight of 280 to 560 g/mol, preferably 320 to 450 g/mol (as determined according to GB/T 7383-2007) in a content of 0.5 to 3 wt %, preferably 0.5 to 2 wt %, more preferably 0.5 to 1.5 wt %, based on the total weight of the component B;

B2) at least one polytetramethylene ether glycol having a weight average molecular weight of 650 to 2000 g/mol, preferably 1000 to 2000 g/mol (as determined according to GB/T 7383-2007) in a content of 80 to 90 wt %, preferably 82˜88 wt %, based on the total weight of the component B.

The ethylene diamine-started polyoxypropylene ether tetraol is namely ethylenediamine polyether tetraol (also known as polyether 403, i.e. ethylenediamine polyether tetraol having a molecular weight of 300). It is prepared from ethylene diamine and propylene oxide (epoxypropane), in which ethylene diamine as a starter and propylene oxide as the main raw material is reacted by ring-opening polymerization in the absence of a catalyst at a temperature of 100 to 110° C.; the obtained crude polyether is then distilled under reduced pressure to give said ethylenediamine polyether tetraol.

The polyester polyol is obtained by reaction of a dicarboxylic acid or a dicarboxylic acid anhydride with a polyol. The dicarboxylic acid is preferably, but not limited to, an aliphatic carboxylic acid having 2 to 12 carbon atoms, such as succinic acid, malonic acid, glutaric acid, adipic acid, suberic acid, azelaic acid, sebacic acid, dodecyl carboxylic acid, maleic acid, fumaric acid, phthalic acid, isophthalic acid, terephthalic acid, and mixtures thereof. The dibasic acid anhydride is preferably, but not limited to, phthalic anhydride, tetrachlorophthalic anhydride, maleic anhydride, and mixtures thereof. The polyol is preferably, but not limited to, ethylene glycol, diethylene glycol, 1,2-propanediol, 1,3-propanediol, dipropylene glycol, 1,3-methylpropanediol, 1,4-butanediol, 1,5-pentanediol, 1,6-hexanediol, neopentyl glycol, 1,10-nonanediol, glycerol, trimethylolpropane, and mixtures thereof. The polyester polyol further includes a polyester polyol prepared from a lactone. The polyester polyol prepared from a lactone is preferably, but not limited to, a caprolactone such as ε-caprolactone polyol.

The polyester polyol has a functionality of 2 to 3 and a hydroxyl number of 20 to 180. A polyester polyol having a functionality of 2 and a hydroxyl number of 28 to 112 is preferable.

The polycarbonate polyol is preferably, but not limited to, a polycarbonate diol. The polycarbonate diol can be prepared by reaction of a diol with a dihydrocarbyl or diaryl carbonate or phosgene. The diol is preferably, but not limited to, 1,2-propanediol, 1,3-propanediol, 1,4-butanediol, 1,5-pentanediol, 1,6-hexanediol, diethylene glycol, trioxymethylene diol or mixtures thereof. The dihydrocarbyl or diaryl carbonate is preferably, but not limited to, diphenyl carbonate.

Chain Extender and/or Crosslinker

The chain extender useful in the present invention is selected from the group consisting of a polyfunctional alcohol or amine compound containing a hydroxyl group or an amino group having a low molecular weight. A commonly used alcohol-based chain extender is selected from the group consisting of 1,4-butanediol (BDO), 1,6-hexanediol, glycerin, trimethylolpropane, diethylene glycol (DEG), triethylene glycol, neopentyl glycol (NPG), sorbitol, diethylaminoethanol (DEAE), and the like. An amine-based chain extender is selected from the group consisting of 3,3′-dichloro-4,4′-diaminodiphenylmethane (MOCA) and liquid MOCA obtained by modification with formaldehyde, ethylene diamine (EDA), N,N-dihydroxy(diisopropyl) aniline (HPA) and the like, as well as hydroquinone-di(β-hydroxyethyl) ether (HQEE).

It is well known to those skilled in the art that the chain extender commonly used in the field of polyurethanes is a di- or polyhydric alcohol having a low molecular weight, a compound containing an amino or an imino group or an ether alcohol. The present invention preferably includes a polyol/alcohol amine-based chain extender having a low molecular weight including, but not limited to, propylene glycol, dipropylene glycol, butylene glycol, ethylene glycol, diethylene glycol, hexanediol, diethanolamine, triethanolamine, diisopropanolamine, triisopropanolamine, and the like. Preferably, the component B of the polyurethane reaction system of the present invention further comprises at least one alcohol, alcohol amine or diamine-based chain extender having a low molecular weight, which is present in a content of 7 to 15 wt %, preferably 9 to 13 wt %, based on the total weight of the component B.

Catalyst

Common catalysts for reaction systems of the polyurethane microcellular elastomer can be classified into the following types: 1) (cyclo)aliphatic tertiary amine catalysts such as triethylene diamine (DABCO), pentamethyl-diethylene triamine, dimethylcyclohexylamine (DMCHA) and N,N-dimethylcyclohexylamine; 2) metal compounds such as organotins, dibutyltin laurate (DBTDL), products UL-4, UL-6, UL-22, UL-28 and UL-32 of UL series from Momentive, etc.; 3) hydroxy-containing catalysts, such as dimethylaminopropyl dipropanolamine (DPA), N-methyldiethanolamine (MDEA) and dimethylaminopropylamine (DMAPA)-Amin Z, etc.; 4) ether amine catalysts, for example bis-N,N′-dimethylaminoethylether, N-ethylmorpholine (NEM) and 2,2-dimorpholinodiethyl ether (DMDEE) and the like.

Tertiary amine catalysts useful in component B include, but are not limited to, triethylamine, tributylamine, dimethylbenzylamine, dicyclohexylmethylamine, dimethylcyclohexylamine, N,N,N′,N′-tetramethyldiaminodiethylether, bis(dimethylaminopropyl)urea, N-methylmorpholine or N-ethylmorpholine, N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, dimethylpiperazine, N-dimethylaminoethylpiperidine, 1,2-dimethylimidazole, 1-azabicyclo-[2.2.0]octane, 1,4-diazabicyclo[2.2.2]octane (Dabco), and alkanolamine compounds such as triethanolamine, triisopropanolamine, N-methyldiethanolamine, and N-ethyldiethanolamine, dimethylaminoethanol, 2-(N,N-dimethylaminoethoxy)ethanol, N,N′,N″-tris(dialkylaminoalkyl)hexahydrotriazines, such as N,N′,N″-tris(dimethylaminopropyl)-hexahydrotriazine, and triethylenediamine Metal salts such as ferric chloride, zinc chloride and lead octoate are also suitable. Preferable are tin salts such as tin dioctoate, tin diethylhexanoate and dibutyltin dilaurate, and in particular mixtures of the tertiary amine and the organotin salt.

Preferably, the catalyst of the polyurethane reaction system of the present invention is present in a content of 0.5 to 2.1 wt %, based on the total weight of the component B.

Preferably, the tertiary amine catalyst of the present invention is selected from one, two or more of the group consisting of triethylenediamine, N-ethylmorpholine, N,N,N′,N′-tetramethyl-ethylenediamine, dimethylaminopropylenediamine, N,N,N′,N′-tetramethyldipropylenetriamine or mixtures thereof and also weak acid-modified products of the above tertiary amine catalysts. The tertiary amine catalyst of the present invention is preferably in a content of 0.5 to 2.0 wt %, based on the total weight of the component B.

Optionally, the catalyst of the present invention includes at least one organotin catalyst. Preferably, the organotin catalyst is selected from one, two or more of the group consisting of alkyltin thiolates, alkyltin mercaptoacetates and long-chain-alkyltin carboxylates. The organotin catalyst is present in a content of 0.02 to 0.10 wt %, based on the total weight of the component B.

Foaming Agent

Component B of the polyurethane reaction system of the present invention may further comprise one or more foaming agents. The foaming agent may be selected from the group consisting of fluorine-based hydrocarbon compounds (hydrofluorocarbon compounds) and/or alternatively selected from the group consisting of acetal-based compounds and/or water. A suitable fluorine-based hydrocarbon compound is Forane® 365 (available from Arkema Inc.). The foaming agent used may be a combination of the above compounds and/or water.

Preferably, the foaming agent is water, which is present in a content of 0.2 to 1 wt %, preferably 0.3 to 0.7 wt %, based on the total weight of the component B.

Colorant/Color Paste

Colorant/color paste, in general, refers to a semi-finished product obtained by dispersing a pigment or a pigment and a filler in a paint. Preferably, the component B of the polyurethane reaction system of the present invention further comprises a color paste, which is present in a content of 0.1 to 5.0 wt %, based on the total weight of the component B.

The polyurethane reaction system may further comprise conventional additives such as a stabilizer, a filler, a mold release agent, and the like.

In an embodiment of the present invention, the polyurethane microcellular elastomer obtained by reaction of the polyurethane reaction system has a resilience of >50%, preferably >51%, more preferably >52%.

The polyurethane microcellular elastomer of the present invention using the ethylene diamine-started polyoxypropylene ether tetraol and corresponding components of the polyurethane reaction system has other satisfactory physical properties such as an excellent resilience effect while having excellent fatigue resistance, and can help with good shock absorption.

Non-Pneumatic Tire

Another aspect of the present invention is to provide a non-pneumatic tire comprising the aforementioned polyurethane microcellular elastomer of the present invention. Preferably, the non-pneumatic tire further comprises a rubber layer disposed on the outer side of the microcellular elastomer.

25

The non-pneumatic tire obtained from the polyurethane microcellular elastomer of the present invention can pass a rigorous fatigue resistance test and has a long service life even when used for non-motor vehicles at high speed (for example 40 km/h). Moreover, because of its excellent resilience performance, it may be well shock-absorbing and may be safer and more comfortable for users when used in non-motor vehicles.

Process for Producing a Non-Pneumatic Tire

The process for producing a non-pneumatic tire provided by the present invention includes injecting a polyurethane reaction system comprising the following components into a mold, and obtaining the non-pneumatic tire by demolding after the reaction is completed:
a component A, one or more polyisocyanates;
a component B, including:
   B1) at least one ethylene diamine-started polyoxypropylene ether tetraol having a weight average molecular weight of 280 to 560 g/mol, preferably 320 to 450 g/mol (as determined according to GB/T 7383-2007) in a content of 0.5 to 3 wt %, preferably 0.5 to 2 wt %, more preferably 0.5 to 1.5 wt %, based on the total weight of the component B;
   B2) at least one polytetramethylene ether glycol having a weight average molecular weight of 650 to 2000 g/mol, preferably 1000 to 2000 g/mol (as determined according to GB/T 7383-2007) in a content of 80 to 90 wt %, preferably 82 to 88 wt %, based on the total weight of the component B;
   B3) one or more catalysts; and
   B4) one or more foaming agents.

In an embodiment of the present invention, the tire further comprises a rubber layer disposed on the outer side of the polyurethane microcellular elastomer.

In an embodiment of the present invention, the mold includes space for forming a non-pneumatic tire, and preferably, the inside of the mold has space for forming a bicycle tire; more preferably, the mold is a mold that can realize centrifugal casting.

Preferably, the polyurethane reaction system is injected by centrifugal casting. The process for producing a non-pneumatic tire of the present invention can be selected from various processes. For example, preferably, in the process 1, the components of the polyurethane reaction system are injected in corresponding proportions into a mold in a mode of centrifugal casting, and the non-pneumatic tire (inner tube) of polyurethane microcellular elastomer is obtained by foaming and curing, and then a rubber outer tube is disposed on the outer side of the inner tube to obtain the non-pneumatic tire. Optionally, in the process 2, the rubber outer tube is firstly placed in a mold, and the components of the polyurethane reaction system are injected in corresponding proportions into the mold in a mode of centrifugal casting, and the non-pneumatic tire is obtained by foaming and curing. Preferably, the polyurethane microcellular elastomer can also be cured at room temperature or under heating condition in an oven to obtain the non-pneumatic tire.

### EXAMPLES

The present invention will be specifically described below by way of examples.

The test methods used in the present invention are as follows:

Hardness (Asker C): determined according to the method of DIN ISO 7619.

Tensile strength: determined according to the method of DIN ISO 37, method 1.

Elongation at break: determined according to DIN ISO 37, method 1

Tear strength: determined according to the method of DIN ISO 34-1-2004, method 1.

Resilience: determined according to the method of ASTM D1054.

Fatigue resistance test (running durability test) refers to the test method according to JIS

K6302-2011 standard with a load of 70 kg, continuous running of 3000 km at 40 km/h

(Comparative Example 1 at 15 km/h). If the tire is intact, it means that it passes the test.

TABLE 1
Sources of raw materials used in the examples

| category | raw materials | description | Source/supplier |
|---|---|---|---|
| Component A | ISO 1 | MDI isocyanate/PTMEG 2000 | Made in laboratory |
| | | prepolymer, NCO content 19.2 wt % | |
| | Desmodur | MDI isocyanate/polyether polyol | Covestro Polymers (China) |
| | 10IS14-C | prepolymer, NCO content 20.0 wt % | Co., Ltd. |
| Component B | Desmophen | Ethylene diamine-started | Covestro Polymers (China) |
| | 4050E | polyoxypropylene ether tetraol, | Co., Ltd. |
| | | hydroxyl number 630 mgKOH/g | |
| | DED-28 | Propylene glycole started polyether | |
| | | polyol, molecular weight 4000 | |
| | BDO | 1,4-butanediol | Related market |
| | MOCA | 3,3′-dichloro-4,4′- | Suzhou Xiangyuan |
| | | diaminodiphenylmethane | Chemical Co., Ltd. |
| | EG | Ethylene glycol | Related market |
| | PTMEG 2000 | Polytetramethylene ether glycol, | Changchun Chemical Co., |
| | | hydroxyl number 56, molecular | Ltd. |
| | | weight 2000 g/mol | |
| | Niax L 1500 | Surfactant | Momentive Performance |
| | | | Materials Inc. |
| | MESOPU ® | Color paste | Bomexchem Co., Ltd. |
| | 030-9I0722 | | |
| | DABCO | Tertiary amine catalyst | Airproducts |
| | 33LV | | |
| | Niax A - 400 | Tertiary amine catalyst | Momentive Performance |
| | | | Materials Inc. |
| | UL-32 | Organotin catalyst | Momentive Performance |
| | | | Materials Inc. |
| | DABCO T-12 | Dibutyltin laurate catalyst | Eastman Co., Ltd. |
| | Irganox 1076 | antioxidant | |
| | Irganox 1135 | antioxidant | |

Preparation of ISO1 in Table 1:

373 g of polytetramethylene ether glycol (PTMEG 2000) was placed in an oven at about 50° C., melted into a liquid, and then added to a four-necked flask. 567 g of Desmodur 44C (pure MDI) and 60 g of Desmodur CD-C (liquefied MDI) were added. After they reacted at 70 to 80 t for 2 to 3 hours, samples were taken and NCO contents thereof were measured. When a certain value (19.2 wt %, based on the total weight of the component A) was reached, the temperature was lowered. A NCO-terminated prepolymer ISO1 was thus obtained.

Preparation of Polyurethane Microcellular Elastomers and Non-Pneumatic Tires:

Components of the polyurethane reaction system in the following Examples or Comparative Examples were injected into a mold. After the reaction was completed, the tire-like polyurethane microcellular elastomer was obtained by demolding. A rubber outer tube was then placed on the outer side of the polyurethane microcellular elastomer. The non-pneumatic tire (24 inch) was thus obtained.

TABLE 2
Components of Comparative Example 1 and test results thereof

| | Content in wt % | |
|---|---|---|
| Components | | |
| DED-28 | 43.264 | |
| PTMEG 2000 | 43.264 | |
| EG | 11.248 | |
| DABCO 33LV | 0.727 | |
| Irganox 1076 | 0.303 | |
| Irganox 1135 | 0.13 | |
| Niax A-400 | 0.208 | |
| DABCO T-12 | 0.017 | |
| Niax L-1500 | 0.389 | |
| Water | 0.45 | |
| Total | 100 | |
| Desmodur 10IS14-C | 93 | |
| Performance | | |
| Packed density | 400 | kg/m³ |
| Hardness (Asker C) | 70 to 75 | |
| Tensile strength | 3.0 | MPa |
| Elongation at break (%) | 255 | |
| Tear strength | 6.4 | kN/m |
| Resilience (%) | 39 | |
| Initial decomposition temperature (TGA) | 262° | C. |

| | |
|---|---|
| Fatigue resistance test | Not pass |

TABLE 3
Components of Example 1, Comparative Examples
2 and 3 and test results thereof

| | content (g) | | |
|---|---|---|---|
| | Ex. 1 | Comp. Ex. 2 | Comp. Ex. 3 |
| Component | | | |
| PTMEG 2000 | 85.22 | 86.22 | 84.50 |
| EG | 0.00 | 0.00 | 7.00 |
| BDO | 12.00 | 5.00 | 7.00 |
| MOCA | 0.00 | 7.00 | 0.00 |
| Desmophen 4050E | 1.00 | 0.00 | 0.00 |
| DABCO 33LV | 0.60 | 0.60 | 0.40 |
| Niax A-400 | 0.20 | 0.20 | 0.12 |
| UL-32 | 0.03 | 0.03 | 0.03 |
| Niax L-1500 | 0.45 | 0.45 | 0.45 |
| Water | 0.50 | 0.50 | 0.50 |
| Total (g) | 100.00 | 100.00 | 100.00 |
| NCO content of ISO 1 | 19.2 | 19.2 | 19.2 |
| (wt %) | | | |
| ISO 1 content (g) | 91.00 | 70.00 | 106.00 |
| Performance | | | |
| Packed density kg/m³ | 400 | 400 | 400 |
| Hardness (Asker C) | 70 to 75 | 70 to 75 | 70 to 75 |
| Tensile strength (MPa) | 3.63 | 3.25 | 4.6 |
| Elongation at break (%) | 283 | 260 | 283 |
| Tear strength (KN/m) | 5.57 | 4.75 | 6.48 |
| Resilience (%) | 53 | 48 | 46 |
| Initial decomposition | 311 | 311 | 288 |
| temperature (TGA) | | | |
| Fatigue resistance test | pass | Not pass | Not pass |

It is known from the above experimental test results that the tire prepared in Example 1 passed the fatigue resistance test of the present invention based on JIS K6302-2011 standard with running of 3000 km at 40 km/m, and the tire was intact. The tire prepared in Comparative Example 1 was tested with a load of 70 kg at 15 km/h. After 37.5 km, the polyurethane microcellular elastomer of said tire was severely collapsed, and the test could not continue. Said tire failed the test. The tire prepared in Comparative Example 2 was damaged after continuous running for 175 km and failed the fatigue resistance test. The tire prepared in Comparative Example 3 was damaged after continuous running for 16 km and failed the fatigue resistance test.

Moreover, it is apparent from the drawings that the tire of Example 1, i.e. the non-pneumatic tire (inner tube) obtained from the polyurethane elastomer of the present invention remained intact after the fatigue resistance test. However, the inner tubes of Comparative Examples 2 and 3 were damaged or deformed.

While the present invention has been described with its preferable embodiments as above, such embodiments are not intended to limit the present invention. It is obvious to those skilled in the art that various changes and modifications can be made without departing from the spirit and scope of the present invention. The protection scope of the present invention should be determined by the scope of the claims of the present patent application.

1. A polyurethane microcellular elastomer obtained from a reaction system comprising:
a component A, one or more polyisocyanates; and
a component B, including:
B1) at least one ethylene diamine-started polyoxypropylene ether tetraol having a weight average molecular weight of 280 to 560 g/mol determined according to GB/T 7383-2007, in a content of 0.5 to 3 wt % based on the total weight of the component B;
B2) at least one polytetramethylene ether glycol having a weight average molecular weight of 650 to 2000 g/mol as determined according to GB/T 7383-2007, in a content of 80 to 90 wt % based on the total weight of the component B;
B3) one or more catalysts; and
B4) one or more foaming agents.

2. The polyurethane microcellular elastomer according to claim 1, wherein the polyisocyanate is a NCO-terminated isocyanate prepolymer having a NCO content of 15 to 25 wt % as determined according to GBT 18446-2009, based on the total weight of the isocyanate prepolymer.

3. The polyurethane microcellular elastomer according to claim 1, wherein the B4) foaming agent is water, which is present in a content of 0.2 to 1 wt % based on the total weight of the component B.

4. The polyurethane microcellular elastomer according to claim 1, wherein the reaction system further comprises B5) at least one alcohol, alcohol amine or diamine-based chain extender having a low molecular weight, which is present in a content of 7 to 15 wt % based on the total weight of the component B.

5. The polyurethane microcellular elastomer according to claim 1, wherein the reaction system further comprises B6) a surfactant, which is present in a content of 0.1 to 1.0 wt % based on the total weight of the component B.

6. The polyurethane microcellular elastomer according to claim 1, wherein the polyurethane microcellular elastomer has a resilience of >50%.

7. A non-pneumatic tire comprising a polyurethane microcellular elastomer obtained from a reaction system comprising:
a component A, one or more polyisocyanates; and
a component B, including:
B1) at least one ethylene diamine-started polyoxypropylene ether tetraol having a weight average molecular weight of 280 to 560 g/mol (as determined according to GB/T 7383-2007, in a content of 0.5 to 3 wt % based on the total weight of the component B;
B2) at least one polytetramethylene ether glycol having a weight average molecular weight of 650 to 2000 g/mol as determined according to GB/T 7383-2007, in a content of 80 to 90 wt % on the total weight of the component B;
B3) one or more catalysts; and
B4) one or more foaming agents.

8. The non-pneumatic tire according to claim 7, wherein the polyisocyanate is a NCO-terminated isocyanate prepolymer having a NCO content of 15 to 25 wt % as determined according to GBT 18446-2009, based on the total weight of the isocyanate prepolymer.

9. The non-pneumatic tire according to claim 7, wherein the B4) foaming agent is water, which is present in a content of 0.2 to 1 wt % based on the total weight of the component B.

10. The non-pneumatic tire according to claim 7, wherein the reaction system further comprises B5) at least one alcohol, alcohol amine or diamine-based chain extender having a low molecular weight, which is present in a content of 7 to 15 wt % based on the total weight of the component B.

11. The non-pneumatic tire according to claim 7, wherein the reaction system further comprises B6) a surfactant, which is present in a content of 0.1 to 1.0 wt % based on the total weight of the component B.

12. The non-pneumatic tire according to claim 7, wherein the polyurethane microcellular elastomer has a resilience of >50%.

13. The non-pneumatic tire according to claim 7, wherein the non-pneumatic tire further comprises at least a rubber layer disposed on the outer side of the polyurethane microcellular elastomer.

14. A process for producing a non-pneumatic tire according to claim 7, comprising:
injecting a polyurethane reaction system into a mold, reacting, and then releasing the resultant from the mold after the completion of the reaction to obtain the non-pneumatic tire, wherein the polyurethane reaction system comprises:
a component A, one or more polyisocyanates; and
a component B, including:
B1) at least one ethylene diamine-started polyoxypropylene ether tetraol having a weight average molecular weight of 280 to 560 g/mol determined according to GB/T 7383-2007, in a content of 0.5 to 3 wt % based on the total weight of the component B;
B2) at least one polytetramethylene ether glycol having a weight average molecular weight of 650 to 2000 g/mol as determined according to GB/T 7383-2007, in a content of 80 to 90 wt % based on the total weight of the component B;
B3) one or more catalysts; and
B4) one or more foaming agents.

15. The process according to claim 14, further comprising disposing at least a rubber layer on the outer side of the non-pneumatic tire.

16. A non-motor vehicle comprising the non-pneumatic tire according to claim 7, wherein the non-motor vehicles have at least two wheels, which may reach a speed of <50 km/h.

17. A non-motor vehicle comprising at least one non-pneumatic tire according to claim 7.

18. The non-motor vehicle according to claim 17, wherein the non-motor vehicle is a bicycle.

19. The non-motor vehicle according to claim 17, wherein said at least one non-pneumatic tire refers to two non-pneumatic tires.
